(19) United States
(12) Patent Application Publication
(10) Pub. No.: US 2017/0132703 A1
(43) Pub. Date: May 11, 2017

(54) SYSTEMS AND METHODS FOR EVALUATING LIQUIDITY OF A MARKET

(71) Applicant: Bloomberg Finance L.P., New York, NY (US)

(72) Inventors: Aditya Oomman, Brooklyn, NY (US); Patrick Stetter, New York, NY (US); Aaron Lobb, Erie, PA (US); Charles Broderick, New York, NY (US); Zokir Tiliaev, Brooklyn, NY (US)

(73) Assignee: Bloomberg Finance L.P., New York, NY (US)

(21) Appl. No.: 15/347,483

(22) Filed: Nov. 9, 2016

Related U.S. Application Data
(60) Provisional application No. 62/254,020, filed on Nov. 11, 2015.

(51) Int. Cl. G06Q 40/04; G06Q 30/02

(52) U.S. Cl. CPC G06Q 40/04; G06Q 30/0201

(57) ABSTRACT

Systems and methods are provided for calculating a liquidity metric. A spline is fit to a set of securities. A model yield to maturity is calculated based on the spline for each security in the set of securities. A market yield to maturity is calculated based on market data for each security in the set of securities. A liquidity metric is calculated for the set of securities based on the calculated model yields to maturity and the calculated market yields to maturity.

### CROSS-REFERENCE TO RELATED APPLICATIONS

This application claims the benefit of Provisional Patent Application No. 62/254,020, filed Nov. 11, 2015, the disclosure of which is incorporated herein by reference in its entirety.

### TECHNICAL FIELD

The present invention relates generally to market liquidity and more particularly to systems and methods for evaluating liquidity of a market.

### BACKGROUND OF THE INVENTION

Market liquidity refers to the ability to buy or sell an asset in a financial market. Market liquidity is important to the proper functioning of financial markets due to its impact on the price of an asset. In a liquid financial market, the asset may be sold quickly with little impact on its price. However, in an illiquid financial market, the asset cannot be sold quickly without a reduction in price.

The liquidity of a financial market is difficult to measure. Conventionally, liquidity has been evaluated by monitoring certain measures of individual assets. For example, measures such as, e.g., the bid-ask price, the volume, and the depth of the order book and price impact can be monitored to evaluate the liquidity of a particular asset. However, it remains a challenge to encapsulate all of the liquidity information of individual assets into a single aggregate metric representing the liquidity of the financial market as a whole. Further, calculating such liquidity measures is a computationally intensive process, taking hours to complete. As such, real time monitoring of a financial market's liquidity is not possible using conventional methods.

### SUMMARY

In accordance with one embodiment, a discount curve factor engine is provided for calculating one or more liquidity metrics. The discount curve factor engine fits a spline to a set of securities (e.g., bonds). A model yield to maturity is calculated based on the spline for each security in the set of securities. A market yield to maturity is calculated based on market data for each security in the set of securities. A liquidity metric is calculated for the set of securities based on the calculated model yields to maturity and the calculated market yields to maturity. Advantageously, a liquidity metric for a market as a whole is calculated that can be tracked in real time.

In one embodiment, the spline is a piecewise cubic spline or a piecewise exponential spline. The splines are fit to the set of securities determined by filtering a larger universe of securities based on exclusion rules. The splines may be fit at predetermined, periodic intervals of time.

In one embodiment, the model yield to maturity for a security is calculated by determining a model price for the security and converting the model price to the model yield to maturity. The model price may be determined by applying the discount functions extracted from the fitted spline to cash flow information of the security. Similarly, the market yield to maturity for a security is calculated by converting a composite price of the security to a yield to maturity.

In one embodiment, the liquidity metric comprises one or more of: a fitted spread for the set of securities representing a difference between the market yield to maturity and the model yield to maturity; and a value of the minimized room mean square error between the market yield to maturity and the model yield to maturity.

These and other advantages of the invention will be apparent to those of ordinary skill in the art by reference to the following detailed description and the accompanying drawings.

### BRIEF DESCRIPTION OF THE DRAWINGS

FIG. 1 shows a high-level diagram of a communications system, in accordance with one embodiment;

FIG. 2 shows a high-level system architecture of a discounted curve factor engine, in accordance with one embodiment;

FIG. 3 shows a system architecture of the spline calculation module of the discounted curve factor engine, in accordance with one embodiment;

FIG. 4 shows a system architecture of the model calculation module of the discounted curve factor engine, in accordance with one embodiment;

FIG. 5 shows an exemplary intra-day liquidity index, in accordance with one embodiment;

FIG. 6 shows an exemplary chart displaying R-square values, in accordance with one embodiment;

FIG. 7 shows an exemplary user interface for accessing fitted splines, in accordance with one embodiment;

FIG. 8 illustratively depicts a flow diagram of a method of operation of the discount curve factor engine, in accordance with one embodiment; and

FIG. 9 shows a high-level block diagram of a computer for a discount curve factor engine, in accordance with one embodiment.

### DETAILED DESCRIPTION

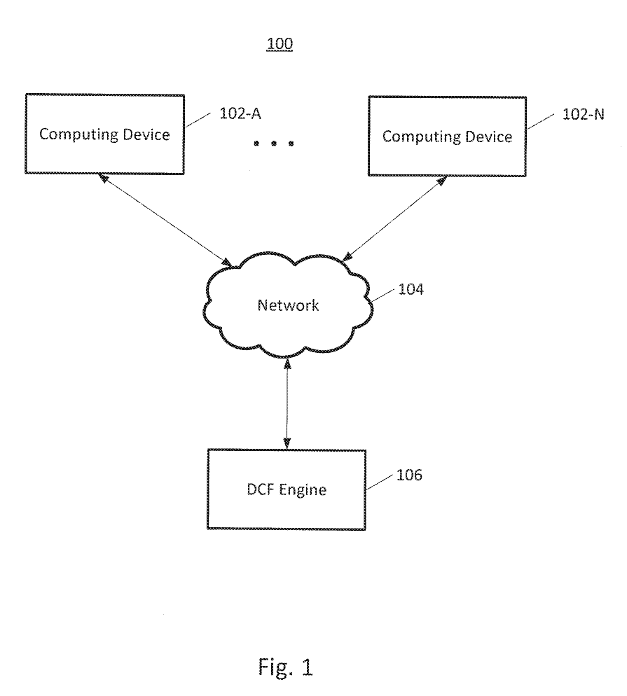

FIG. 1 shows a high-level diagram of a communications system 100, in accordance with one or more embodiments. Communications system 100 includes computing devices 102-A, . . . , 102-N (collectively referred to as computing devices 102). Computing devices 102 may comprise any type of computing device, such as, e.g., a computer, a tablet, a mobile device, a server, or a database. In one embodiment, computing devices 102 may be operated by end users for communicating via network 104. Network 104 may include any type of network or combinations of different types of networks, and may be implemented in a wired and/or a wireless configuration. For example, network 104 may include one or more of the Internet, an intranet, a local area network (LAN), a wide area network (WAN), a Fibre Channel storage area network (SAN), a cellular communications network, etc.

Discounted curve factor (DCF) engine 106 may interact with computing devices 102 via network 104 to evaluate the liquidity of a financial market. In one embodiment, end users of computing devices 102 may communicate via network 104 for interacting with DCF engine 106 to evaluate the liquidity of the financial market. For example, end users may interact with DCF engine 106 via an interface of a web browser executing on computing device 102, an application executing on computing device 102, an app executing on computing device 102, or any other suitable interface for interacting with analyzer engine 106.

Traditionally, systems for calculating liquidity metrics evaluate liquidity on an individual security basis. Calculations to determine these traditional metrics are computationally intensive such that real time monitoring using these traditional metrics is not possible. Traditional systems for calculating liquidity metrics are thus unable to provide an aggregate liquidity metric for evaluating liquidity of a market as a whole performed in real time (or near real time).

Advantageously, embodiments of the present invention described herein provide for DCF engine 106, which utilizes a novel computational process for the real time evaluation of liquidity of a market. The computational process performed by DCF engine 106 reduces the computational expense for evaluating liquidity of a market, thus allowing the evaluation of liquidity of a market to be performed in real time (or near real time). DCF engine 106 in accordance with embodiments of the invention thus provides for improvements in computer functionality by facilitating the evaluation of liquidity of a market in real time, which was not possible with conventional systems.

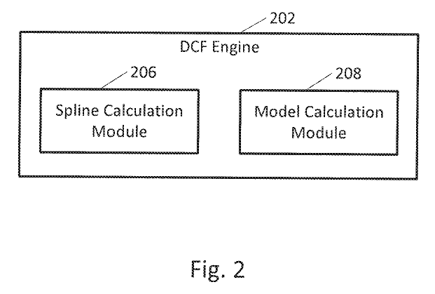

FIG. 2 shows a high-level system architecture for a DCF engine 202, in accordance with one or more embodiments. In one embodiment, DCF engine 202 is DCF engine 106 of FIG. 1.

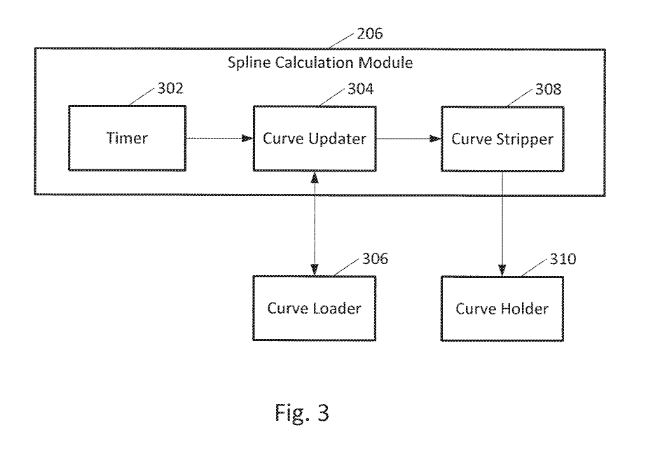

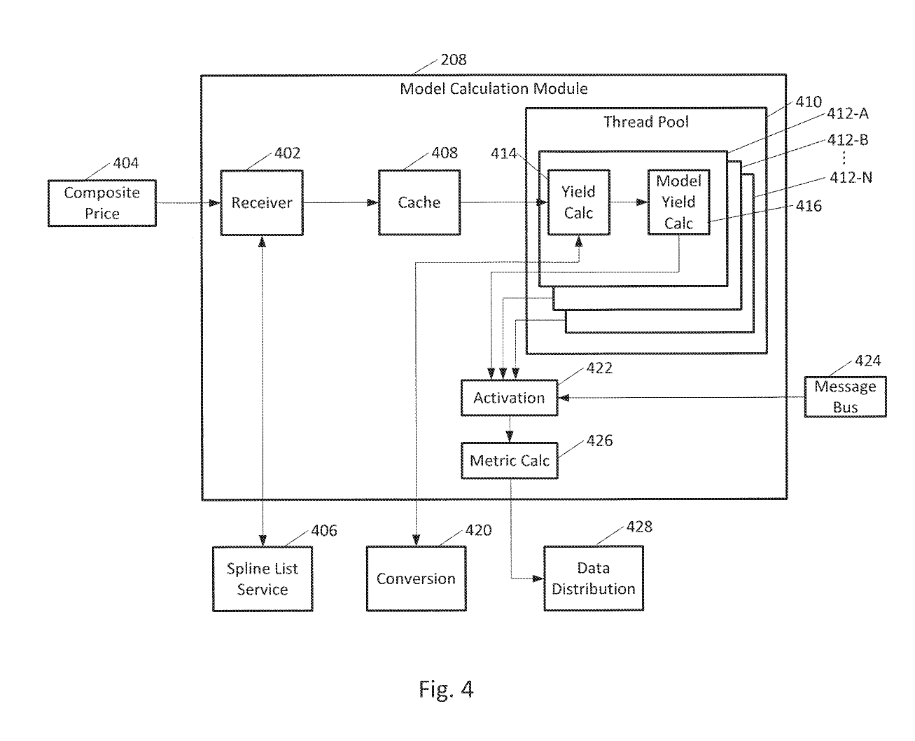

DCF engine 202 comprises a spline calculation module 206 and a model calculation module 208. Spline calculation module 206 calculates splines for a determined set of securities. A spline is a numeric function that is piecewise-defined by polynomial functions that are joined at user-selected knot points for approximating or interpolating other functions. A spline may be represented as a curve with the Y axis representing maturity of the security and the X axis representing discount factors. Spline calculation module 206 calculates splines by fitting market data of securities (e.g., bonds) in the universe of securities to splines. Model calculation module 208 evaluates liquidity of a market by calculating one or more liquidity metrics using the splines. Details of spline calculation module 206 and model calculation module 208 will be discussed below with respect to FIGS. 3 and 4, respectively.

FIG. 3 shows a system architecture of spline calculation module 206, in accordance with one or more embodiments. Spline calculation module 206 includes a timer 302 configured to trigger curve updater 304 to generate splines at predetermined times. In one embodiment, timer 302 is configured to trigger curve updater 304 at periodic intervals of time, such as, e.g., every 500 milliseconds. Once triggered by timer 302, curve updater 304 retrieves reference data for generating splines from curve loader 306, e.g., via an application service. Curve updater 304 may retrieve the reference data for a set of securities. In one embodiment, the set of securities comprises a set of bonds, however the set of securities may also comprise other financial instruments. The set of securities may be determined as an “in-sample” universe of securities from a universe comprising all securities associated with a market. The in-sample universe of securities may be generated, e.g., daily based on a set of exclusion rules.

In one embodiment, if at the time that timer 302 triggers the calculation of a spline, there is no price associated with more than a predetermined amount (e.g., 20%) of the in-sample universe, a spline is not created. Curve loader 306 will attempt to retrieve reference data for generating a spline at the next interval triggered by timer 302.

In one embodiment, the set of exclusion rules may filter out securities that trade with a large liquidity premium or a large concession. Factors that drive liquidity differential can vary across markets. For example, in the U.S. Treasury market, it has been found that on-the-run (OTR) securities are more liquid than off-the-run (OFR) securities and therefore command a liquidity premium reflected by a lower yield for the OTR compared to the OFRs. In contrast, in the German government bond market, it has been found that deliverability into note and bond futures contracts is the primary driver of liquidity as opposed to benchmark status.

In one embodiment, the set of exclusion rules filter out one or more of the following securities to generate the in-sample universe: bills; callable bonds (for historical fits) and floaters; treasury inflation-protected securities (TIPS); separate trading of registered interest and principal securities (STRIPS); bonds with remaining maturities less than half a year; OTR and first OFR securities; original issue 30-year bonds with remaining maturity less than 10 years; original issue 10-year notes with remaining maturity less than 5 years; original issue 7-year notes with remaining maturity less than 5 years; and original issue 5-year notes with remaining maturity less than 2 years. Other exclusion rules may also be applicable.

Curve loader 306 loads the in-sample universe of securities and returns reference data of the in-sample universe to curve updater 304. The reference data may include, e.g., settlements, coupon frequency, compounding frequency, currency and calendar conventions, etc. In one embodiment, curve loader 306 retrieves the reference data from an external repository or database (not shown). Curve stripper 308 fits one or more splines to the reference data provided by curve updater 304. In one embodiment, curve stripper 308 fits both a piecewise exponential spline and a piecewise cubic spline on the reference data. In one embodiment, only the piecewise cubic spline is used for publishing a liquidity index or root mean square error due to its superior fitting capability.

Splines are preferred over parametric models such as Nelson Seigel (NS) or Nelson Seigel Svensson (NSS) since these parametric models suffer from insufficient localization in that small changes in the front end of the curve could drive spurious changes to the long end of the curve. Additionally, while these parametric models produce smooth curves, the possible shapes that the fitted parametric models can assume are limited. As such, parametric models are not sufficiently flexible for the purpose of bond-specific relative value applications.

Curve stripper 308 interpolates discount factors from the fitted splines. The fitted splines define a relationship between a functional form for the underlying forward curve and a discount factor for any time horizon. For example, a step-forward functional form for the continuous forward curve may be employed for a piecewise exponential spline while a quadratic functional form for the continuous forward curve may be employed for a piecewise cubic spline. The interpolated discount factors may be extracted from the fitted splines. The splines and extracted discount factors are stored by curve holder 310 for use by model calculation module 208.

FIG. 4 shows a system architecture of model calculation module 208, in accordance with one or more embodiments. Model calculation module 208 uses the splines and extracted discount factors calculated by spline calculation module 206 to generate one or more liquidity metrics.

Model calculation module 208 includes receiver 402, which receives composite price 404 for securities (e.g., in the in-sample universe) from, e.g., an external database (not shown). Composite price 404 is a composite of various market quotes for a particular security for sovereigns meeting inclusion criteria. The inclusion criteria is determined at startup using reference data, which may be retrieved from a repository (not shown) by spline list service 406. In one embodiment, any inclusion criteria may be applied as is known in the art. Cache 408 receives composite price 404 and gathers bid and ask messages together for the securities.

In order to achieve the desired update frequency, thread pool 410 employs a parallel processing framework for performing calculations. The calculations are performed for any number of securities in parallel. For example, thread pool 410 may perform calculations for all securities in the in-sample universe, all securities outside the in-sample universe, all securities in the universe, etc. Thread pool 410 includes threads 412-A, 412-B, . . . , 412-N, where N is any positive integer (collectively referred to as threads 412). In one embodiment, N is the number of securities for which calculations are to be performed by thread pool 410 such that each thread 412 performs calculations for a particular security. Each thread 412 includes a yield calculator 414 and a model yield calculator 416 for performing calculations.

Yield calculator 414 interacts with conversion module 420 to convert composite price 404 of a security to a yield to maturity value. In one embodiment, composite price 404 of the security is converted to a yield to maturity value using known techniques.

Model yield calculator 416 receives the most recently generated spline and extracted discount factors from curve holders 310 of spline calculation module 206 of FIG. 3. The spline is at first initialized with a set of starting parameters. A model price is calculated from the spline initialized with the starting parameters based on the security's cash flow and extracted discount factors. In one embodiment, the model price may be calculated using known techniques. The security's cash flow is determined based on reference data of the security, which may be retrieved from a repository or database (not shown). The reference data may include, e.g., settlements, coupon frequency, compounding frequency, currency and calendar conventions, etc. A spline (e.g., piecewise cubic spline or piecewise exponential spline) is “fit” to the cash flow data of the security. The process of “fitting” is mathematically equivalent to minimizing the root mean square error (RMSE) across the fitting universe. The RMSE is a measure of the average absolute error between the model yield and market yield across the fitting universe as defined in Equation (1) below. An optimizer perturbs the parameters of the spline looking for a reduction in the RMSE. Once the RMSE converges to a particular value for some level of tolerance, the optimization is halted and the parameters of the fitted spline are stored. The model price is determined from the optimized spline and converted to a yield. In one embodiment, the model price is converted to a yield using known techniques.

The results of the calculations for each security determined by threads 412 are received by activation module 422. Activation module 422 determines whether the calculations performed by threads 412 are to be published to metric calculator 426 and data distribution system 428. In one embodiment, multiple instances of DCF engine 202 exist. A centralized monitoring system (not shown) registers the instances, which are then assigned priorities by an automatic timer starting job mechanism (not shown). The centralized monitoring system designates the instance with the highest priority as the primary instance. When the primary instance ceases responding to uptime notifications (or heartbeats), e.g., after a predetermined amount of time, the next highest priority instance is designated as the primary instance. Upon receiving a message from the centralized monitoring system (via message bus 424) indicating that the particular instance of DCF engine 202 is the primary instance, activation module 422 passes the results of the calculations for each security from threads 412 to metric calculator 426. The message from message bus 424 may be sent, e.g., via a multicast protocol from the centralized monitoring system. If activation module 422 does not receive a message from message bus 424, activation module 422 identifies the particular instance of DCF engine 202 as a silent but ready backup instance (i.e., not the primary instance) and does publish the results of the calculations to metric calculator 426 and data distribution system 428.

Metric calculator 426 calculates one or more metrics of liquidity. In one embodiment, metric calculator 426 calculates one or more of the following metrics: an aggregate liquidity metric; fair value model (i.e., spline) yields for all securities in a universe (not just those fitted to the spline); and fitted spreads of all securities in a universe. Metric calculator 426 may also calculate other metrics in accordance with the present principles.

Metric calculator 426 receives results of the calculations determined by threads 412 (via activation module 422) to calculate metrics. In one embodiment, metric calculator 426 reduces errors between theoretical (i.e., model) yields and market yields of securities by minimizing the root mean square error (RMSE). The RMSE is defined in Equation (1) below.

$$RMSE = \sqrt{\frac{{Σ [ YTM ( market ) - YTM ( model ) ]}^{2}}{n}} \qquad Equation ( 1 )$$

where YTM(market) is the yield to maturity for a security derived from its market price, YTM(model) is the yield to maturity for the security derived from its model price determined from the fitted spline, and n is the number of securities used for fitting the spline. The YTM(market) and YTM(model) are calculated for a security by yield calculation module 414 and model yield calculation module 416, respectively. The difference between YTM(market) and YTM(model) is summed for each security in the in-sample universe.

In one embodiment, metric calculator 426 returns the minimized RMSE as the aggregate liquidity metric.

In another embodiment, metric calculator 426 returns the spline associated with the minimized RMSE. The spline represents all securities in the universe in the currency of the spline. The currency of the spline refers to the currency of the underlying securities in the fitting universe

The RMSE is a measure of the average yield error across the fitting universe (e.g., the in-sample universe). The errors between a security's theoretical model yields and the security's market yields are reduced by minimizing the RMSE. Once the spline is fitted to the in-sample universe of securities by minimizing the RMSE, fitted spreads of all securities in the universe (i.e., including securities that were previously filtered out are) are calculated. The fitted spread of a security represents the difference between the market yield of the security and its corresponding model spline yield. In Equation (1), the quantity defined as the YTM(market) less the YTM(model) is referred to as the fitted spread of the security. The fitted spread is determined for all securities in the universe and aggregated to provide for a measure of the liquidity. The aggregation of the fitted spread is mathematically equivalent to the summary in Equation (1). In one embodiment, metric calculator 426 returns the fitted spreads as a measure of liquidity of the universe.

Positive values for the fitted spreads represent bonds that are trading relatively “cheap” to the fair value fitted curve and typically required a liquidity concession for investors to buy them. Well-seasoned U.S. Treasuries which have rolled down the curve and have to compete with the more recently issued benchmark OTRs often trade at a liquidity concession.

Negative values for the fitted spreads represent bonds that are trading relatively “rich” to the fitted curve and typically represent bonds that trade at a liquidity premium because they are highly demanded collateral. The OTR and the first OFR that the U.S. Treasury issues usually trade rich as they are used by the dealer community for hedging purposes. Similarly, the cheapest-to-deliver bond into the front Treasury futures contract often trade rich to the curve.

In some embodiments, an alternative formulation may be employed that minimizes the errors between the bonds theoretical and market price, rather than yields. However, this approach is not as favored because the lower price risk of shorter duration bonds implicitly assigns lower weight for equal yield errors relative to longer duration bonds, resulting in larger yield fitting errors at the front end. Directly minimizing errors in yields as in Equation (1) ensures that the errors are weighted uniformly across the term structure.

In another embodiment, an RMSE is also calculated across the entire universe of securities (e.g., U.S. Treasury notes with a remaining maturity of one year or greater) based on the intra-day values of the RMSE. Intra-day values of this RMSE are ticked through the liquidity index ticker every time a new tick comes in for any of the securities in the universe. This RMSE is a measure of prevailing intra-day aggregate liquidity in the universe (e.g., U.S. Treasury market).

Metric calculator 426 sends the generated metrics of liquidity for publishing to data distribution system 428. Data distribution system 428 may publish the metrics to, e.g., databases, data models, transport networks, permissioning systems, client/server systems, or any other destination. In some embodiments, the metrics are published to ticker plants.

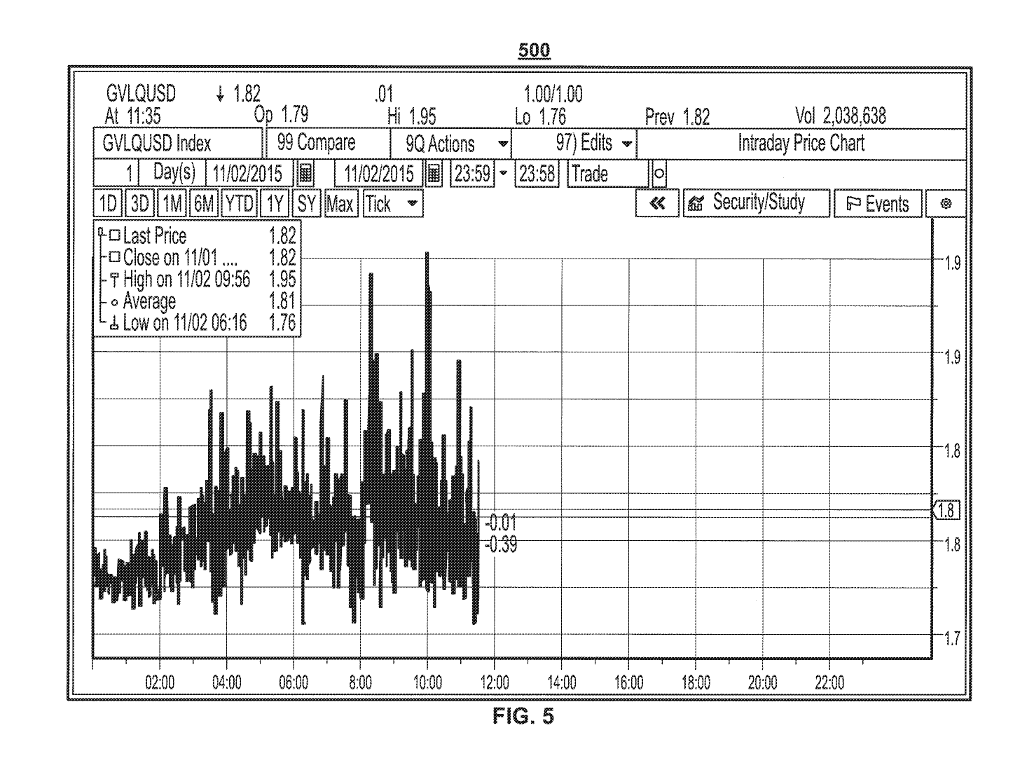

FIG. 5 shows an intra-day liquidity index 500. When liquidity conditions are favorable, the index value representing average yield errors is small, as any dislocation from fair values is normalized within a short time frame. Under stressed liquidity conditions and limited availability of risk capital, dislocations from fair values implied by the fitted spline can remain persistent, resulting in a larger index value due to “liquidity tiering.” As shown in FIG. 5, the liquidity index 500 can be monitored intra-day. Liquidity index 500 may be ticked from, e.g., the start of trading in Tokyo the previous day to 5:00 pm of the current day in New York City. An end of day history for the liquidity index may also be presented going back several years and spanning multiple liquidity events. A fitted spread is ticked for a bond if its last price is refreshed.

The component processes that make up the liquidity index include: 1. Creation of the in-sample universe; 2. Least square spline optimization triggered by timer 302; 3. Dynamic rules for determining the in-sample universe; 4. Calculation of the liquidity index (using the full sample RMSE) based on the fitted spline on a tick by tick basis using composite prices; and 5. Publishing the liquidity index to a ticker on a tic-by-tic basis. The synergy of these component processes has led to unexpected results: the tic-by-tic capability to measure and monitor aggregate market liquidity.

The performances of fitted splines calculated using the methods described herein were evaluated by comparing changes in the model yields with changes in the market yields. The changes in the model yields, estimated using the fitted spline, were found to track changes in market yields. The coefficient of determination or R-square (a measure of how well the model explains the variability of outcomes) was computed between market yield changes and model yield changes over 5 years for seven representative bonds across the yield curve. The results for daily, weekly, and monthly yield changes are displayed below in Table 1 and indicate a high R-square between actual and fitted yield changes. Similar results were obtained for other bonds in the universe.

TABLE 1
results for yield changes indicating a high R-square between
actual and model yield changes:

| | T | T | T | T | T | T | T |
|---|---|---|---|---|---|---|---|
| | 4.25% | 3.625% | 6.25% | 6.375% | 5.375% | 4.5% | 4.375% |
| Changes | 11/15/17 | 2/15/20 | 8/15/23 | 8/15/27 | 2/15/31 | 02/15/36 | 05/15/40 |
| 1 d | 0.994 | 0.996 | 0.998 | 0.998 | 0.997 | 0.997 | 0.999 |
| 5 d | 0.995 | 0.997 | 0.998 | 0.999 | 0.998 | 0.998 | 0.997 |
| 10 d | 0.996 | 0.998 | 0.999 | 0.999 | 0.998 | 0.998 | 1.00 |
| 20 d | 0.996 | 0.998 | 0.999 | 0.999 | 0.998 | 0.997 | 0.999 |

Changes between fitted spread and yields in Table 2 below display low R-squares, confirming that fitted spreads generally tend not to be market directional.

TABLE 2
results for yield changes indicating a low R-square between
actual and model yield changes:

| | T | T | T | T | T | T | T |
|---|---|---|---|---|---|---|---|
| | 4.25% | 3.625% | 6.25% | 6.375% | 5.375% | 4.5% | 4.375% |
| Changes | 11/15/17 | 2/15/20 | 8/15/23 | 8/15/27 | 2/15/31 | 02/15/36 | 05/15/40 |
| 1 d | 0.007 | 0.006 | 0.050 | 0.031 | 0.035 | 0.028 | 0.003 |
| 5 d | 0.009 | 0.011 | 0.047 | 0.041 | 0.018 | 0.009 | 0.004 |
| 10 d | 0.007 | 0.019 | 0.072 | 0.103 | 0.053 | 0.024 | 0.005 |
| 20 d | 0.000 | 0.057 | 0.089 | 0.117 | 0.049 | 0.039 | 0.003 |

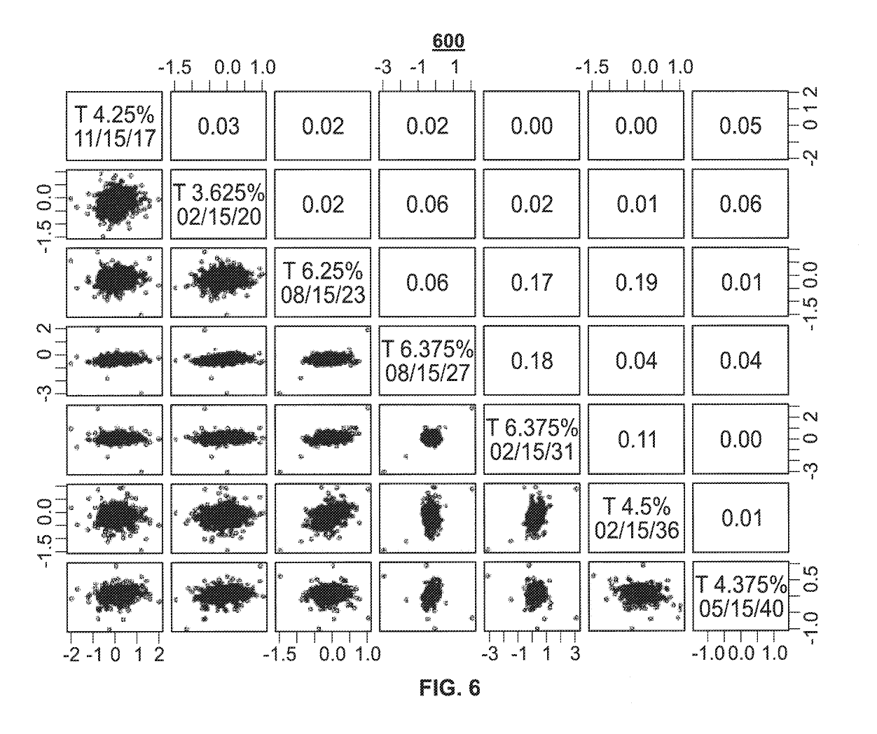

FIG. 6 shows a chart 600 displaying R-square values corresponding to daily changes in the model spread. The upper right diagonal portion of cells in chart 600 displays the R-squares corresponding to the daily changes in the fitted spreads of the two bonds in the respective row and column. Similarly, the lower left diagonal portion of chart 600 displays scatter plots of the daily changes of these fitted spreads. For example, the reported R-square between T 3.625% 2/15/20 and T 5.375% 02/15/31 is 0.02 implying that the daily change in the fitted spread of one of these bonds explains only 2% of the variability of daily changes in the fitted spread of the other.

Chart 600 shows that, generally, the R-squares are close to 0.0 in most cases underscoring that the fitted spreads represent idiosyncratic risk of each bond rather than any factor risk common to all bonds. The scatter plots confirm the weak to non-existent linear relationship between changes in fitted spreads. When the R-square is larger than zero, it is clear from the scatter plots that these modestly elevated levels are due to the presence of outliers. This is to be expected; large changes in fitted spreads are usually the result of a macroeconomic shock and fitted spreads of seasoned bonds are likely to track each other more closely as their respective liquidity premia are driven by a common risk factor under these special circumstances. Similar results were obtained across most of the remaining bonds in the universe.

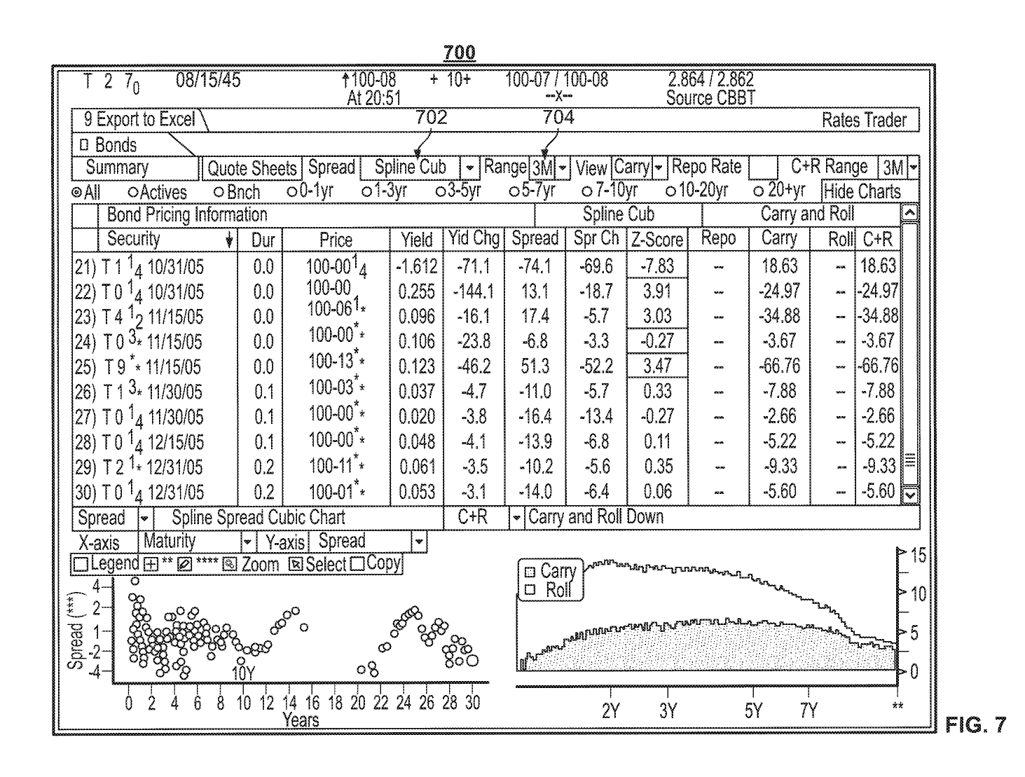

FIG. 7 shows an exemplary user interface 700 for accessing fitted splines, in accordance with one or more embodiments. User interface 700 may be a user interface of computing device 102 of FIG. 1. An end user may interact with user interface 700 to select a fitted spline using the “Spread” drop down 702. The most recent value of the fitted spread is displayed under the spread column alongside its historical range and Z-score. The selected spread's z-score is a measure of its dislocation from its rolling average measured in historical standard deviations of this spread over the same period. The window used to calculate a single z-spread value can be selected through the “Range” drop down 704. From a relative value perspective, it is important to analyze the z-score of the fitted spread in addition to its absolute value, as some bonds will trade systematically rich or cheap to the fitted curve.

As described above, spline calculation module 206 of FIG. 3 fits market data associated with a set of securities to a piecewise cubic spline or a piecewise exponential spline. The following is a mathematical specification of the piecewise cubic spline and the piecewise exponential spline.

The functional form of the piecewise cubic spline is the piecewise quadratic continuously compounded forward rate. The first derivative of the forward rate is continuous at knot points and zero at the beginning and at the last maturity time. The discount factor of the piecewise cubic spline curve is defined in Equation (2).

D(t)=exp(−L(t)) Equation (2)

The log discount factor L(t) is defined in Equation (3).

$$L ( t ) = {λ}_{0} \cdot t + \frac{1}{6} {\sum }_{{T}_{n} < t}^{ } {{λ}_{n} ( t - {T}_{n} )}^{3} - \frac{1}{6} P \cdot {t}^{3} \qquad Equation ( 3 )$$

where Tₙ is the n^{th} knot point and n is the number of coefficients; the summation is performed for all n=1, . . . , N−1 such that Tₙ<t, which leads to a curve L(t) being piecewise cubic. At each knot point t=Tₙ a new additional cubic polynomial starts to the right from the point t=Tₙ in a manner which assures that first and second derivatives of L(t) are continuous. The coefficient λₙ (where n=0, . . . , N−1) are independent parameters. The last coefficient, λ_{N}, is not an independent parameter, but is defined as

$${λ}_{N} = - \frac{1}{{T}_{N}} {\sum }_{n = 1}^{N - 1} {λ}_{n} {T}_{n} .$$

The parameter P is defined as

$$P = {\sum }_{n = 1}^{N - 1} {λ}_{n} .$$

This choice of P assures that for t>Tₙ the cubic term in the log discount factor L(t) (and the quadratic term in the forward rate) is zero. The choice of λ_{N} similarly assures that for t>Tₙ the quadratic term in the log discount factor L(t) (and the linear term in the forward rate) is zero. The piecewise cubic spline curve is smooth (i.e., the forward rate has a continuous first derivative) and satisfies all the boundary conditions (e.g., continuous first derivative of the forward rate at knot points or zero derivatives at the ends of the curve by construction, and it has N degrees of freedom). Changes in parameter λₙ, where n=0, . . . , N−1, lead to changes in λ_{N} and P and thus affects the value of the function everywhere.

The log discount factor L(t) for the piecewise exponential spline is defined to be linear between knot points. Alternatively, the continuously compounded forward rate is piecewise constant between knot points. The log discount factor L(t) is defined in Equation (4).

$$L ( t ) = {λ}_{n + 1} ( t - {T}_{n + 1} ) + {\sum }_{{T}_{n} < t}^{ } {λ}_{n} ( {T}_{n} - {T}_{n - 1} ) \qquad Equation ( 4 )$$

The piecewise exponential spline has a continuous discount function, but the first derivative is discontinuous. The utility of this model is that it is highly localized to the degree that changing the value of any one of the parameters has localized impact to adjacent knot points during the curve fitting/optimization process.

DCF engine 202 of FIG. 2 fits market data associated with a set of securities to a piecewise cubic spline or a piecewise exponential spline according to the mathematical specifications described above. Advantageously, by modelling market data of a set of securities to a spline, DCF engine 202 may provide real time liquidity metrics representing liquidity of the market as a whole.

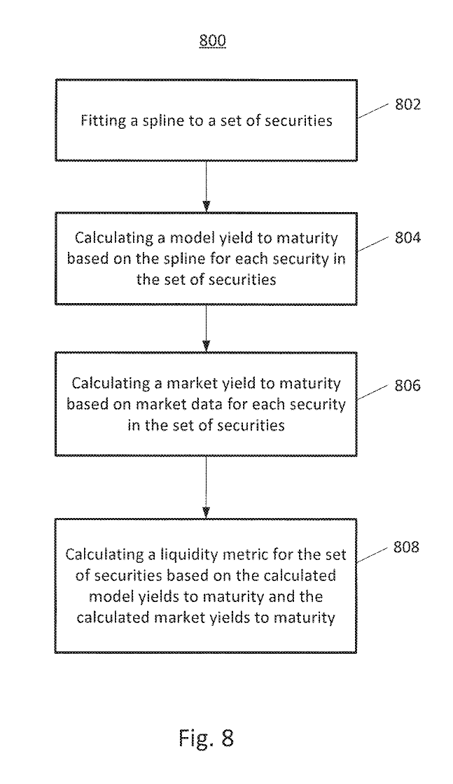

FIG. 8 shows a flow diagram of a method 800 of operation of the DCF engine 202 of FIG. 2, in accordance with one or more embodiments.

At step 802, a spline is fit to a set of securities. The spline may include, e.g., a piecewise cubic spline or a piecewise exponential spline. In one embodiment, the set of securities is determined by filtering a universe of securities (e.g., all securities associated with a market) based on exclusion rules. The exclusion rules may filter out securities that trade with a large liquidity premium or a large concession. The spline may be fit to the set of securities at predetermined, periodic intervals of time (e.g., every 500 milliseconds). The fitted spline may be stripped to extract its discount factors.

At step 804, a model yield to maturity is calculated based on the spline for each security in the set of securities. The model yield to maturity is calculated by first calculating the model price of each security based on its cash flow. The extracted discount factors are applied to the cash flow to generate the model price. The model price is then converted to a model yield to maturity, e.g., using known techniques.

At step 806, a market yield to maturity is calculated based on market data for each security in the set of securities. The market yield to maturity may be calculated by converting the known composite price of each security to the yield to maturity, e.g., using known techniques.

In one embodiment, the model yield to maturity and market yield to maturity are calculated for each security in the set of securities. Calculations for each security may be performed in parallel.

At step 808, a liquidity metric is calculated for the set of securities based on the model yield to maturity and the market yield to maturity calculated for each security in the set of securities. In one embodiment, the liquidity metric comprises a fitted spread for the set of securities representing a difference between the market yield to maturity and the model yield to maturity. In another embodiment, the liquidity metric comprises a value of the minimized room mean square error between the market yield to maturity and the model yield to maturity. Other metrics are also contemplated.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 8. Certain steps of the methods described herein, including one or more of the steps of FIG. 8, may be performed by a server or by another processor in a network-based cloud-computing system. Certain steps of the methods described herein, including one or more of the steps of FIG. 8, may be performed by a client computer in a network-based cloud computing system. The steps of the methods described herein, including one or more of the steps of FIG. 8, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 8, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

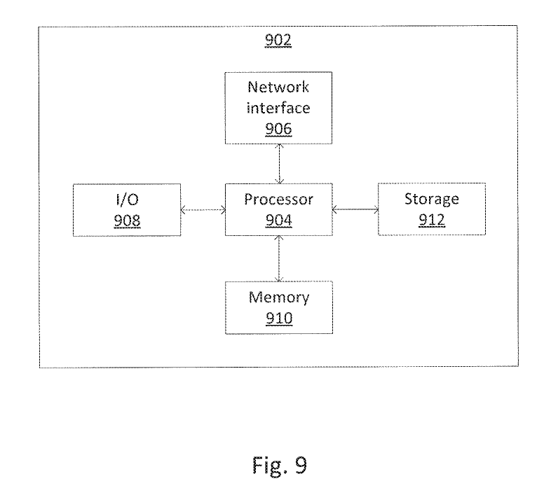

A high-level block diagram 900 of an example computer that may be used to implement systems, apparatus, and methods described herein is depicted in FIG. 9. Computer 902 includes a processor 904 operatively coupled to a data storage device 912 and a memory 910. Processor 904 controls the overall operation of computer 902 by executing computer program instructions that define such operations. The computer program instructions may be stored in data storage device 912, or other computer readable medium, and loaded into memory 910 when execution of the computer program instructions is desired. Thus, the method steps of FIG. 8 can be defined by the computer program instructions stored in memory 910 and/or data storage device 912 and controlled by processor 904 executing the computer program instructions. For example, the computer program instructions can be implemented as computer executable code programmed by one skilled in the art to perform the method steps of FIG. 8. Accordingly, by executing the computer program instructions, the processor 904 executes the method steps of FIG. 8. Computer 902 may also include one or more network interfaces 906 for communicating with other devices via a network. Computer 902 may also include one or more input/output devices 908 that enable user interaction with computer 902 (e.g., display, keyboard, mouse, speakers, buttons, etc.).

Processor 904 may include both general and special purpose microprocessors, and may be the sole processor or one of multiple processors of computer 902. Processor 904 may include one or more central processing units (CPUs), for example. Processor 904, data storage device 912, and/or memory 910 may include, be supplemented by, or incorporated in, one or more application-specific integrated circuits (ASICs) and/or one or more field programmable gate arrays (FPGAs).

Data storage device 912 and memory 910 each include a tangible non-transitory computer readable storage medium. Data storage device 912, and memory 910, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 908 may include peripherals, such as a printer, scanner, display screen, etc. For example, input/output devices 908 may include a display device such as a cathode ray tube (CRT) or liquid crystal display (LCD) monitor for displaying information to the user, a keyboard, and a pointing device such as a mouse or a trackball by which the user can provide input to computer 902.

Any or all of the systems and apparatus discussed herein, including computing devices 102 and discount curve factor engine 106 of FIG. 1 and discount curve factor engine 202 of FIG. 2, may be implemented using one or more computers such as computer 902.

One skilled in the art will recognize that an implementation of an actual computer or computer system may have other structures and may contain other components as well, and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
fitting a spline to a set of securities;
calculating a model yield to maturity based on the spline for each security in the set of securities;
calculating a market yield to maturity based on market data for each security in the set of securities; and
calculating a liquidity metric for the set of securities based on the calculated model yields to maturity and the calculated market yields to maturity.

2. The method of claim 1, wherein calculating the liquidity metric comprises:
calculating a fitted spread for the set of securities as a difference between the calculated market yields to maturity and the calculated model yields to maturity.

3. The method of claim 1, wherein calculating the liquidity metric comprises:
minimizing a root mean square error between the calculated market yields to maturity and the calculated model yields to maturity.

4. The method of claim 1, wherein the spline comprises at least one of a piecewise cubic spline or a piecewise exponential spline.

5. The method of claim 1, wherein fitting the spline to the set of securities comprises:
refitting the spline to the set of securities at periodic intervals of time.

6. The method of claim 1, further comprising:
filtering a plurality of securities based on one or more exclusion rules to generate the set of securities.

7. The method of claim 1, wherein calculating the market yield to maturity comprises:
calculating the market yield to maturity based on a composite price of each security in the set of securities.

8. The method of claim 1, wherein:
calculating the model yield to maturity is performed in parallel for each security in the set of securities; and
calculating the market yield to maturity is performed in parallel for each security in the set of securities.

9. A non-transitory computer readable medium storing computer program instructions, which, when executed on a processor, cause the processor to perform operations comprising:
fitting a spline to a set of securities;
calculating a model yield to maturity based on the spline for each security in the set of securities;
calculating a market yield to maturity based on market data for each security in the set of securities; and
calculating a liquidity metric for the set of securities based on the calculated model yields to maturity and the calculated market yields to maturity.

10. The non-transitory computer readable medium of claim 9, wherein calculating the liquidity metric comprises:
calculating a fitted spread for the set of securities as a difference between the calculated market yields to maturity and the calculated model yields to maturity.

11. The non-transitory computer readable medium of claim 9, wherein calculating the liquidity metric comprises:
minimizing a root mean square error between the calculated market yields to maturity and the calculated model yields to maturity.

12. The non-transitory computer readable medium of claim 9, wherein the spline comprises at least one of a piecewise cubic spline or a piecewise exponential spline.

13. The non-transitory computer readable medium of claim 9, wherein fitting the spline to the set of securities comprises:
refitting the spline to the set of securities at periodic intervals of time.

14. The non-transitory computer readable medium of claim 9, the operations further comprising:
filtering a plurality of securities based on one or more exclusion rules to generate the set of securities.

15. An apparatus comprising:
a processor; and
a memory to store computer program instructions, the computer program instructions when executed on the processor cause the processor to perform operations comprising:
fitting a spline to a set of securities;
calculating a model yield to maturity based on the spline for each security in the set of securities;
calculating a market yield to maturity based on market data for each security in the set of securities; and
calculating a liquidity metric for the set of securities based on the calculated model yields to maturity and the calculated market yields to maturity.

16. The apparatus of claim 15, wherein the spline comprises at least one of a piecewise cubic spline or a piecewise exponential spline.

17. The apparatus of claim 15, wherein fitting the spline to the set of securities comprises:
refitting the spline to the set of securities at periodic intervals of time.

18. The apparatus of claim 15, the operations further comprising:
filtering a plurality of securities based on one or more exclusion rules to generate the set of securities.

19. The apparatus of claim 15, wherein calculating the market yield comprises:
calculating the market yield to maturity based on a composite price of each security in the set of securities.

20. The apparatus of claim 15, wherein:
calculating the model yield to maturity is performed in parallel for each security in the set of securities; and
calculating the market yield to maturity is performed in parallel for each security in the set of securities.
